(19) United States
(12) Patent Application Publication
(10) Pub. No.: US 2005/0044149 A1
(43) Pub. Date: Feb. 24, 2005

(54) System and methodology for facilitating the sale of goods and services

(75) Inventors: Marc Eric Regardie, Washington, DC (US); Jason Barrett Siegel, Fairfax, VA (US); Rajesh Ginne, Herndon, VA (US)

Correspondence Address: Charles B. Lobsenz;Roberts, Mlotkowski & Hobbes, PC, Suite 850, 8270 Greenboro Drive, McLean, VA, 22102, US

(73) Assignee: UFollowUp, LLC., Fairfax, VA (US)

(21) Appl. No.: 10/624,043

(22) Filed: Jul. 21, 2003

(51) Int. Cl. G06F 15/16

(52) U.S. Cl. 709/206; 709/219

(57) ABSTRACT

The present invention comprises a sales process control system (“SPCS”). The SPCS of the present invention is preferably embodied as a software application which may run in various environments and according to various architectures. The SPCS of the present invention offers many different features all of which are designed to automate and implement the most effective sales campaign possible. This is accomplished in various ways including through a control process which allows salesperson-users to design and implement an email communication protocol that automates the generation of emails that are sent to customer leads on a scheduled basis. This process allows control at the salesperson level as well as at the sales manager level and the user interface may be customized by both the sales manager and the salesperson to control access to information, appearance and functionality.

### BACKGROUND

1. Field of the Invention

The present invention relates generally to computer and communications systems more particularly to systems and methods for implementing and facilitating activities associated with the sales cycle for selling goods or services.

2. Background of the Invention

People have been selling things to one another almost since the beginning of time. Over the years, the sales process has evolved in many ways not the least of which is the manner in which the sellers and their agents communicate with buyers and prospective buyers. Even reasonably sophisticated sellers know that communication with prospective customers throughout the sales prospecting and closing cycle is critical to achieving desirable sales results.

Along those lines, and in recent years, a multitude of tools have been developed to assist salespeople and their managers in conducting the sales process towards the goal of closing as many sales as possible. These tools run the spectrum in terms of complexity from the simple appointment book all the way to extremely intricate sales modeling and analysis tools which can be run only on very powerful computers.

In any event, sales professionals know that it is very important to maintain a steady dialogue with prospective customers during all phases of the sales cycle, especially with respect to “high ticket” goods and services. The old adage, “out of sight, out of mind” is especially true in connection with the ongoing process of trying to convert interested prospects into customers that become purchasers of goods or services. Without at least periodic communication from the salesperson, potential customers, unless highly self-motivated towards the target product or service, tend to defer purchase decisions, possibly never completing the target transaction. In contrast, if the salesperson contacts the potential purchaser at various times following the initial indication of interest by the potential purchaser, the product or service remains in the prospective purchaser's mind and it is more likely that a transaction may be consummated.

While a heavy investment of time and possibly money in communicating with and following up with prospective customers may not be cost-effective in connection with low-cost/high-volume goods and services, it is almost always a necessary component of a sales and marketing budget when higher-cost items are involved. One good example of this is residential real estate. In many cases, a home is the largest purchase ever made by a particular consumer. As a result, this sales cycle associated with such a transaction may take many months and may require the salesperson to stay in near-constant communication with the potential customer during the sales cycle.

There are many reasons that this communication is so important. First, the potential purchaser may have questions that need to be answered by the salesperson. For example, the potential homebuyer may have additional questions about the school system, home features, pricing, location etc., that may not have been addressed in previous meetings or communications between the salesperson and the customer. Second, in order to have the best chance of closing the sale, the salesperson may need to keep the potential purchase of a home in the forefront of the customer's mind. For example, the salesperson may wish to encourage the homebuyer to buy a home in the near term as opposed to in the distant future in order to, for example, take advantage of relatively low financing rates or because there is limited inventory. Third, the salesperson may need to drive home the relative advantages of his or her product as against the products of competitors. For example, a new homebuilder may wish to periodically inform the potential homebuyer of the various beneficial features of the homebuilder's homes that may not be available in competitive homes.

As can be seen, there are numerous reasons why it is often important for sales professionals to communicate with their leads during the sales cycle. Communication in this context may take many forms. For example, salespeople may contact and inform their potential buyers through letters and brochures sent through the mail, through email communications, through telephone calls and through face-to-face meetings. There exist many tools available to sales professionals which assist them in communicating, using these various forms, with prospective customers during the sales cycle.

These tools tend to include such functionality as contact management, calendaring and scheduling functions, email communication capabilities, product and service information packaging and customer tracking. Using these tools, sales representatives are able to function more effectively and more efficiently in trying to manage the sales process and close as many sales as possible. In particular, many of these tools are embodied as software programs that run either locally or in a network environment so that data may be shared among users.

As mentioned, while there exist many tools, environments and capabilities which serve to improve sales process management, there remains room for improvement and for new and additional capabilities and features. For example, many of the aforementioned tools and software programs do not lend themselves to robust and efficient customization depending upon the particular sales environment. In other words, these tools do not easily permit users to customize the operation based upon, for example, the particular product or service being marketed, the particular salespersons' preferences in managing the sales process, the particular type of potential customer base being marketed to, or the particular nature of the actual sales process adapted by the seller.

By virtue of the fact that many of these applications represent something akin to a “one size fits all approach”, many of the applications offer either too much or not enough capability for the particular customer. As such, the software can be too difficult for users to learn to use when compared against the expected benefits. By way of example, user interfaces can often be anything but intuitive and salespeople may be hesitant or even unwilling to use the applications.

Further, many of the existing applications do not fully exploit the value of data sharing in the sales environment. While some system and application architectures associated with these tools provide shared access to data between and among salespeople, sales managers and corporate level officers, in many cases this capability is not leveraged to provide the full potential of shared data access. For example, these applications do not generally permit supervisory users to control data access and user interfaces available to their subordinates. Additionally, reporting capability and presentation may be somewhat limited or poorly organized in these applications despite the availability of all necessary data.

Yet another deficiency associated with prior art sales process management systems is the fact that they often require substantial investment in terms of computer and other hardware related purchases. This is compounded by the inherent difficulties which can arise in connection with hardware installation, environment control, maintenance, access control and the like.

### SUMMARY OF THE INVENTION

It is therefore a primary object of the present invention to provide a system and methodology which facilitates and greatly improves the sales process.

It is another object of the present invention to provide a system and methodology which facilitates and greatly improves communication between a seller and its sales agents on the one hand and prospective customers on the other hand.

It is yet another object of the present invention to provide a system and methodology which provides an enhanced broadcast email capability.

It is another object of the present invention to provide an enhanced communication system which permits the easy and intuitive selection of recipients and content associated with various outgoing communications.

It is yet another object of the present invention to provide an enhanced communication system that permits selective control over scheduling of outgoing communications.

It is a still further object of the present invention to permit salespersons to interface with the sales process control system of the present invention in an intuitive and efficient manner through the use of a customizable user interface.

It is a yet further object of the present invention to provide a system which allows an administrator to selectively permit and restrict access to data and reporting capabilities within the system.

It is another object of the present invention to provide a system that automatically generates various reminders to sales agents to assist them in managing the sales process.

These and other objects of the present invention are obtained through the use of a sales process control system (“SPCS”) according to the teachings herein. The SPCS of the present invention is preferably embodied as a software application which may run in various environments and according to various architectures. For example, the SPCS may be network based so as to allow users in a common sales organization to share data and reporting capabilities. Further, the SPCS may take the form of an application service provider (ASP) application which allows some or all users to interact with the system through, for example, a web browser function. Data in this case may be centrally stored on a server and selectively made available to various classes of users and particular individuals based upon built in permissioning functionality. The SPCS of the present invention may also take the form of an enterprise application with the application residing on a central server or with some or all of the application being distributed across the enterprise network. Various other environments and architectures may alternatively be employed.

According to a preferred embodiment of the invention, users may interact with the SPCS through various devices including, by way of example only, personal computers, personal digital assistants (PDAs), wireless phones and other wireless devices as well as other tools and devices which permit communication between the user and the SPCS.

As will be described in greater detail below, the SPCS of the present invention offers many different features all of which are designed to automate and implement the most effective sales campaign possible. This is accomplished in various ways including through a control process which allows salesperson-users to design and implement an email communication protocol that automates the generation of emails that are sent to customer leads on a scheduled basis. This process allows control at the salesperson level as well as at the sales manager level and the user interface may be customized by both the sales manager and the salesperson to control access to information, appearance and functionality.

The SPCS of the present invention has wide application and may be used in connection with the sales process associated with the sale or proposed sale of any good or service. By way of example and certainly not by way of limitation, the SPCS may be used in connection with the sales of new homes, re-sale homes, cars, boats and many other big ticket and lesser priced goods. The SPCS may further be used in connection with the other applications which are not necessarily targeted at the sale of a product or service but nonetheless require entity to entity, entity to individual or individual to individual interaction. Examples of these types of applications include the rental of apartments and other real estate, college student and athlete recruiting, mortgage and banking prospecting and application processing, and insurance sales and application processing. Many other possibilities also exist.

As will be recognized from the detailed description below, the SPCS and related methodologies disclosed herein offer many advantages in connection with the sales process and more specifically the interaction between the salesperson and the customer during that process. In even more general terms, the present invention provides an automated capability for communication between an individual or organization on the one hand, and a grouping of targeted recipients on the other hand, where the individual or organization desires to periodically communicate information to the targeted recipients.

These and other advantages and features of the present invention are described herein with specificity so as to make the present invention understandable to one of ordinary skill in the art.

### BRIEF DESCRIPTION OF THE DRAWINGS

FIG. 1 is schematic diagram illustrating an exemplary communication network incorporating the sales process control system (“SPCS”) according to the teachings of the present invention;

FIG. 2 is a block diagram illustrating the various functional components of the SPCS of the present invention;

FIG. 3 is an exemplary screen shot illustrating an exemplary input screen for creating a new system account;

FIG. 4 is an exemplary screen shot illustrating an exemplary input screen for managing system users;

FIG. 5 is an exemplary screen shot illustrating an exemplary input screen for providing information about a prospect as well as sending an initial communication;

FIG. 6 is an exemplary screen shot illustrating an exemplary input screen for sending a broadcast communication; and

FIG. 7 is an exemplary screen shot illustrating an exemplary input screen for administering system templates.

### DETAILED DESCRIPTION OF THE INVENTION

The present invention is now described generally to provide the reader with an overview of the system of the present invention and its use according to the preferred embodiments of the invention. Following the general description, a detailed discussion of each of the components, their use and the way they work together is provided.

The present invention is generally directed to a system and methodology for managing and control the sales process including the implementation of a communications protocol and system for use during the sales cycle.

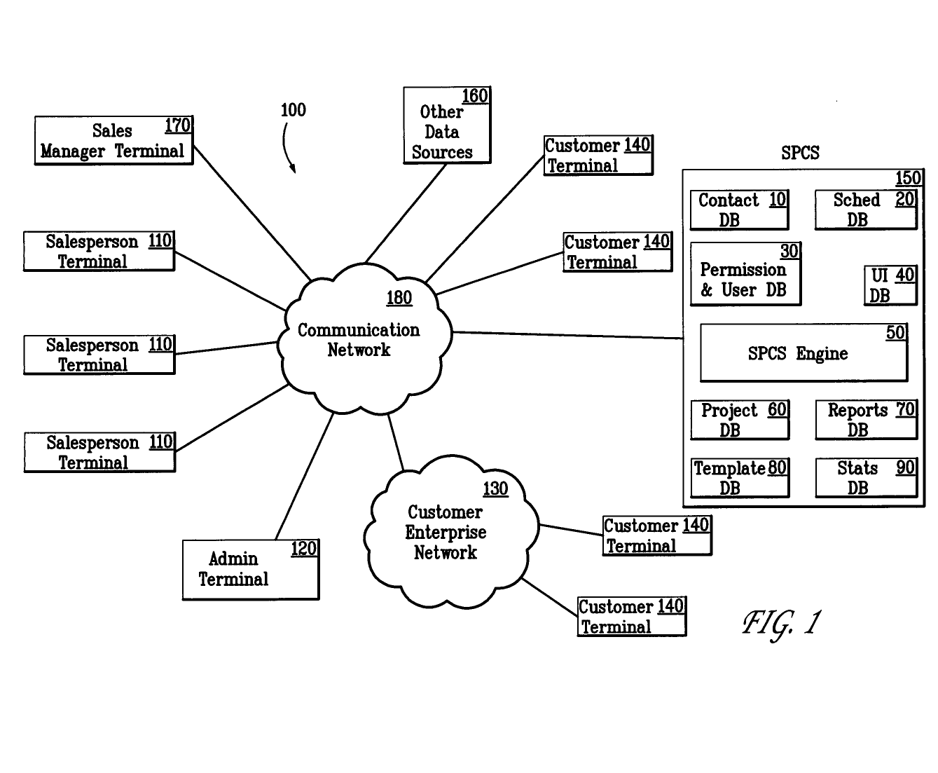

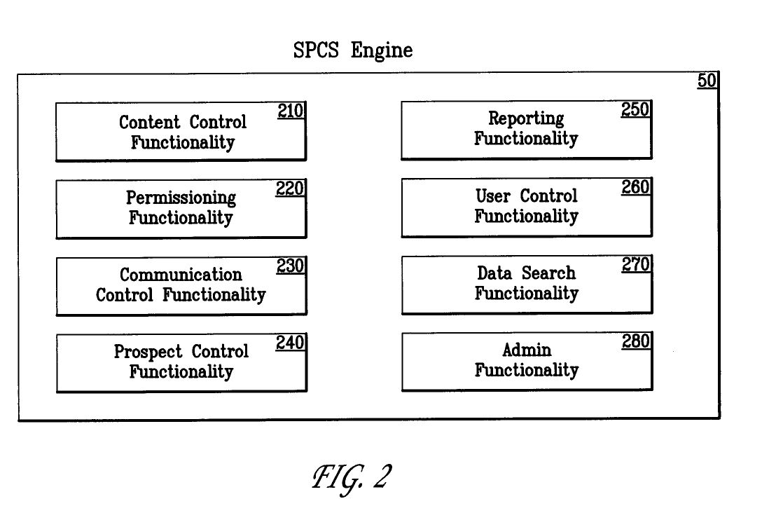

With reference to FIG. 1, a potential communications network and related environment, within which the SPCS of the present invention may operate, is discussed. The network 100 may include an essentially unlimited number of salesperson terminals 110 through which salespersons may interact with the SPCS 150 of the present invention. In addition to salesperson terminals, an essentially unlimited number of customer terminals 140 may also communicate with SPCS 150. Communication, including, for example, receiving and transmitting data is accomplished via communications network 180. In one embodiment, communications network 180 may be the internet although other possibilities exist such as private networks and public networks other than the internet.

Both customer terminals 140 and salesperson terminals 110 may take many forms such as a personal computer, personal digital assistant (PDA) or various wireless devices such as wireless telephones and related devices. Other devices may also be used so long as they permit the user to input data in some fashion and to view or otherwise perceive received data in some fashion. Customer terminals 140 may access communications network 180 via a customer enterprise network 130 such as may be found in a typical corporate setting. Alternatively, customer terminals 140 may have more direct access to communications network 180 such as through an internet service provider (ISP). Salesperson terminals 110 may access communications network 180 directly. Alternatively (not shown), salesperson terminals 110 may access communications network 180 through an enterprise or other network as discussed above and as known in the art.

Network 100 may further include one or more sales manager terminals 170 and one or more administrator terminals 120, both of which may take the same form as discussed above with respect to salesperson terminals 110 and customer terminals 140. In general terms and as will be discussed in greater detail below, salesperson terminals 110 are used by salespeople seeking to sell a good or service while sales manager terminals 170 are used by supervisory employees of the selling organization. Sales manager terminals 170 are used by sales managers and others with higher level privileges with respect to data and functionality. The administrator terminals 120 represent input/output devices that are used by individuals with specialized functionality and data access rights as will be discussed in greater detail below.

The network 100 of the present invention further includes the sales process control system (SPCS) 150 which is at the heart of the teachings herein. SPCS 150 is discussed in detail below. A general description, however, is now provided. SPCS 150 includes SPCS engine 50 which is responsible for the processing accomplished by SPCS 150. By way of example, SPCS engine 50 may be implemented as one or more central processing units (CPUs) running software instructions available in computer program storage. In this same vein, SPCS 150 may be implemented as a computer server with available storage for program instructions and program related data as is known in the art.

SPCS 150 preferably includes a number of readily accessible databases. These may be implemented in actuality as a single database or otherwise with appropriate data structures as is known in the art. SPCS 150 preferably includes a content database 10 which is used to store content in various media formats to be included in communications transmitted by salespersons to potential customers as more fully described below. In addition, content database 10 may store other content related to emails and related attachments which are to be sent to prospects. For example, in the case of an embodiment for use with the sale of new home communities, the data entered through an “Add a Community” or similar interface may be stored in content database 80. In this case, as a builder adds new communities to the system, related content such as photos, descriptions and the like can be added to the system and stored in content database 10.

A scheduling database 20 is also preferably included. Scheduling database stores information concerning the timing of communications which are to be sent by the selling organization to the potential customers. SPCS 150 also preferably includes a permissions and user database 30 which stores information concerning the selling organization user information and related access rights available to those users. By way of example, this database may contain information concerning each of the salespersons and sales managers which have access to SPCS 150. Additionally, SPCS 150 preferably includes a user interface database 40 which contains various user interface components and groupings as they may be available to salespersons and sales managers working on behalf of the selling organization.

Prospect database 60 is another component of SPCS 150. This database contains information about all potential customers including, for example, email addresses and other contact information. SPCS 150 may also contain reports database 70 which houses various configurations and formats for system reports which may be generated by SPCS 150 and made available to those working for the selling organization. Template database 80 stores available templates for communications which may be sent by salespersons to prospective customers. For example, these templates may be represented as layouts for multimedia emails which are available for use by salespeople in communicating with prospects. Statistics database 90 may also be included. This database stores information concerning communications sent to prospects and responsive actions by prospects as a result of the receipt of the communications.

Various other data sources 160 are accessible via and through communications network 180. These data sources 160 may be used to supplement the information available to SPCS 150. By way of example, and not limitation, data sources 160 may comprise internet websites, databases and computer servers containing specific data relevant to the processing undertaken by SPCS 150.

As will be apparent to one of skill in the art, the actual architecture and implementation of the system of the present invention may take many forms. By way of example and not limitation, SPCS 150 may be operated as an application service provider (ASP) solution residing on a common server. In this way, sales organizations and their personnel can access SPCS 150 via a web browser interface and through communications network 160.

Alternatively, SPCS may be implemented as a local software product such that some or all of the components and related functionality are loaded onto a user network and or individual computing devices. Other architectures and implementations are also possible without departing from the scope or spirit of the present invention.

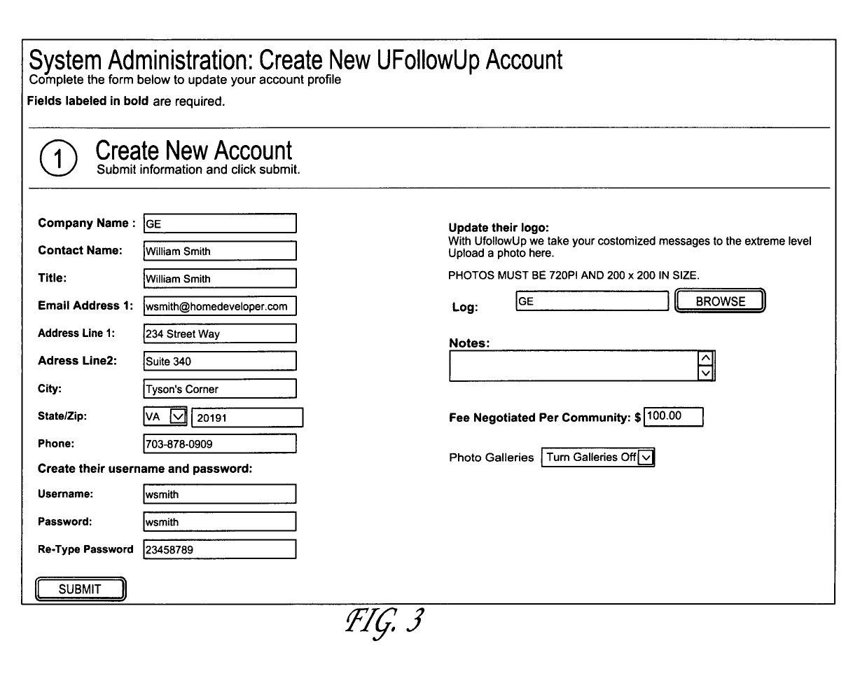

Turning now to FIG. 2, a broad and general description of the various functional components of SPCS engine 50 is next provided. Each of these components are now described in general terms with a more detailed description provided below.

Content control functionality 210 is a component of SPCS engine 50 which serves to control the content available for use in communications sent by salespersons to prospects. This includes, for example, input, organization, processing, editing and retrieval of content which is made available to SPCS 150. Permissioning functionality component 220 serves to control data access and functionality access available to various users associated with the selling organization. For example, this functionality includes controlling access to reports and to particular user interfaces available to salespersons as is discussed in greater detail below.

Communication control functionality 230 serves to control the communications which are transmitted from the selling organization to the prospects. This may include, for example, selection of prospect communication groupings, scheduling of communications and selection of content for specific communications. Prospect control functionality 240 is the component of SPCS engine 50 which controls administration of prospect database 60. This may include, for example, entry of new prospects and related contact information, deletion of prospects in the database and editing of information associated with particular prospects.

Reporting functionality component 250 controls the generation and formatting of reports which are made available to selling organization personnel. User control functionality component 260 controls and administers permissions and user database 30 and related information. For example, this component provides processing associated with adding and deleting salespersons and sales managers within SPCS 150. Data search component 270 controls processing associated with searching for data within any of the databases within SPCS 150. For example, this component provides the ability for users to search for information about prospects, communications, salespersons, and other information associated with and/or collected in connection with the sales cycle. Finally, admin functionality component 280 provides processing available to administrators via administration terminal 120. This processing may include setting up new selling organizations to use SPCS 150 and controlling permissions within SPCS 150 at the user, organizational and overall system level. Each of the above mentioned components and related processing is discussed in much greater detail below.

Each of the specific components and databases of SPCS 150 is now discussed in greater detail along with the specific operation of the system according to various preferred embodiments.

A. System Administration

The overall operation of SPCS 150 is controlled by administration component 280. Administration component 280, as with all components discussed herein, may be implemented as one or more software modules within a computer software program. Administration component 280 controls all high level system control functions many of which are effected by an administrator issuing commands via administration terminal 120. It should be understood that system administrative functions generally correspond to system level controls which take an overall effect on both organizational level and user level functions. In other words, when administrative level operational characteristics are changed via administration component 280, all organizations and individual salespersons associated with such organizations will be affected by the changes. In one example, the system of the present invention may be offered by a solution provider via an ASP solution to a number of sales organizations (e.g. multiple homebuilders) each having a number of salespersons and sales managers. When the solution provider makes an administrative change via administration terminal 120 or otherwise, each of the subscribing organizations and their salespeople will be affected by the changes.

Examples of administrative changes that may be completed via administration terminal include the addition of new subscribing entities to the system, the adjustment of billing properties for some or all of the subscribing entities, the adjustment of service levels available to each of the subscribing entities and other changes which affect usage properties associated with some or all of the subscribing entities. Access to the administration terminal 120 and to the use of administration component 280 is preferably password protected and available to only a limited number of people.

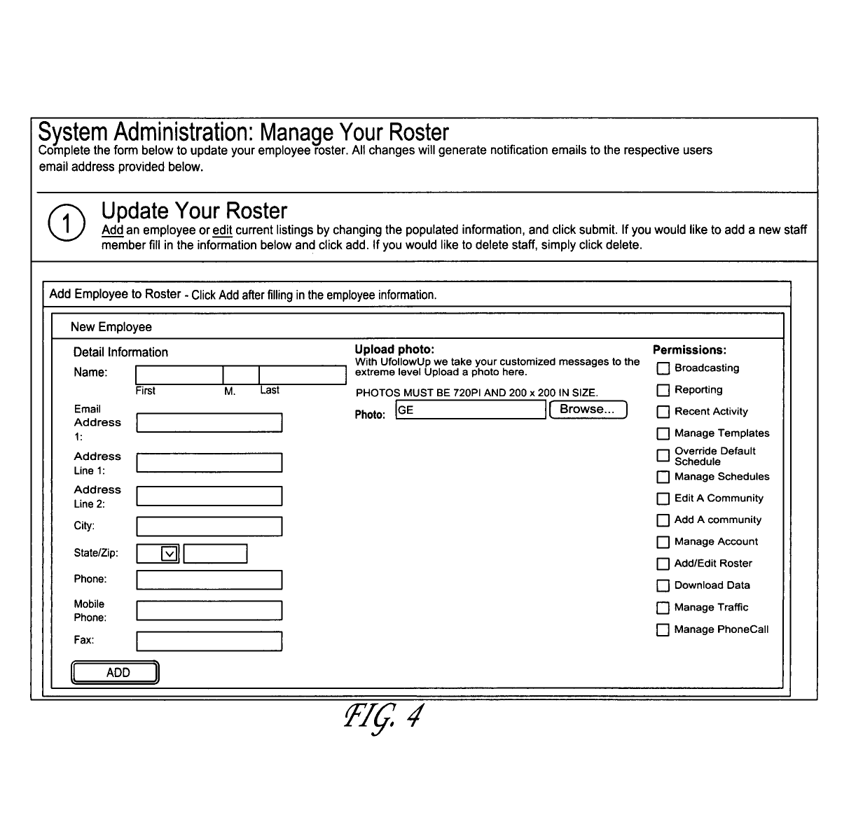

FIG. 3 is an exemplary screen shot illustrating one possible input form for allowing, for example, a service provider, to add a new account to the system. Thus, through the use of this screen, a service provider may, for example, add a new homebuilder to the list of homebuilders that have access to SPCS 150 and can use the same for managing its sales cycle process. As can be seen in FIG. 3, a service provider or its designee enters a series of information to create a new organizational user account. This screen and the information collected is merely an example and as will be apparent, additional or different data may be collected and the layout and elements of the screen may be completely different while remaining within the scope and spirit of the invention. In this example, an administrator is queried for a company name 310, a contact name 320, a title 330 and an email address 340. Additionally, the administrator is requested to provide a mailing address 350 and a phone number 360. A username 370 and password 380 is set up for the organizational account holder. Relevant billing information 390 for the particular organization may also be provided through this input screen. The information is submitted via submit button 395 and the relevant data is stored within the permission and user database 30 of SPCS 150.

B. User Control Features

The user control features discussed in this section are controlled via user control component 260 of SPCS 150. This class of features generally corresponds to the addition and deletion of users (e.g. salespersons and sales managers) within a subscribing organization with access to SPCS 150. In addition, profiles and related information with respect to each user may be created and modified. In most cases, user control is accomplished at the organizational level. For example, in the case of a system operated by a service provider and subscribed to by a number of homebuilders, each homebuilder may have access and responsibility for maintaining the permission and user database 30 with respect to its salespersons and its sales managers. Management via user control component 260 may be accomplished via sales manager terminal 170, admin terminal 120 or any other means for communicating with SPCS 150. Access to the user control functionality of SPCS 150 is preferably password protected.

FIG. 4 is an exemplary screen showing a possible input screen which may be used by a subscribing organization or by a service provider to create a salesperson or sales manager account within SPCS 150. As can be seen in this figure, a new employee/salesperson may be added and various information provided. In this example, a name 410, email address 420, mailing address 430 and phone number 440 are provided. A username and password 460 is also created for the user. Optionally, a photo of the particular employee 450 may be uploaded for various uses within SPCS 150.

Additionally, capability for editing and deleting information associated with particular employees as well as the capability to delete employees from the organizational roster with access to SPCS 150 may also be provided. Information obtained from the input screen in FIG. 4 and in connection with the user control process 260 may be stored in permission and user database 30.

C. Permissioning Control

As can be seen in FIG. 4, permissioning boxes 460 may be individually selected or not selected by the user setting up the salesperson or sales manager account. As can be seen from the figure, many different access control categories (including ones not shown in FIG. 4) may be specified for each individual salesperson or sales manager. For example, a user may be selectively permitted to broadcast emails, retrieve system reports, access recent sales activity, manage templates, override the default event scheduling, manage event scheduling, edit and/or add communities, manage accounts, add to or edit the salesperson roster, download data, manage traffic and manage the phone call processing.

D. User Ooperational Features

Now that the overall control aspects and operational characteristics of SPCS have been described, a discussion of the particular operational features from the point of view of the individual salesperson or sales manager, as applicable, is provided. Although these features are described in the context of a salesperson and in the context of a salesperson working for new homebuilder, it will be readily understood that the present invention is not necessarily limited thereto and various other applications, wherever communication of information via email is desired, are possible while remaining within the scope of the present invention.

The salesperson may use the SPCS 150 of the present invention as a tool to communicate with potential buyers with the goal of closing sales. In that context and subject to appropriate level of permissioning, the salesperson preferably communicates with a prospect list via electronic mail. According to this methodology, the operational characteristics are based upon the salesperson or his or her designee providing data to SPCS 150 via salesperson terminal 110 so as to build a contact database for use with the system. This may be accomplished, for example, by requesting visitors to a new homes community sales office to fill out a contact card requesting, for example, a name and email address. Additional data such as a mailing address, phone number, model of interest etc. may also be obtained.

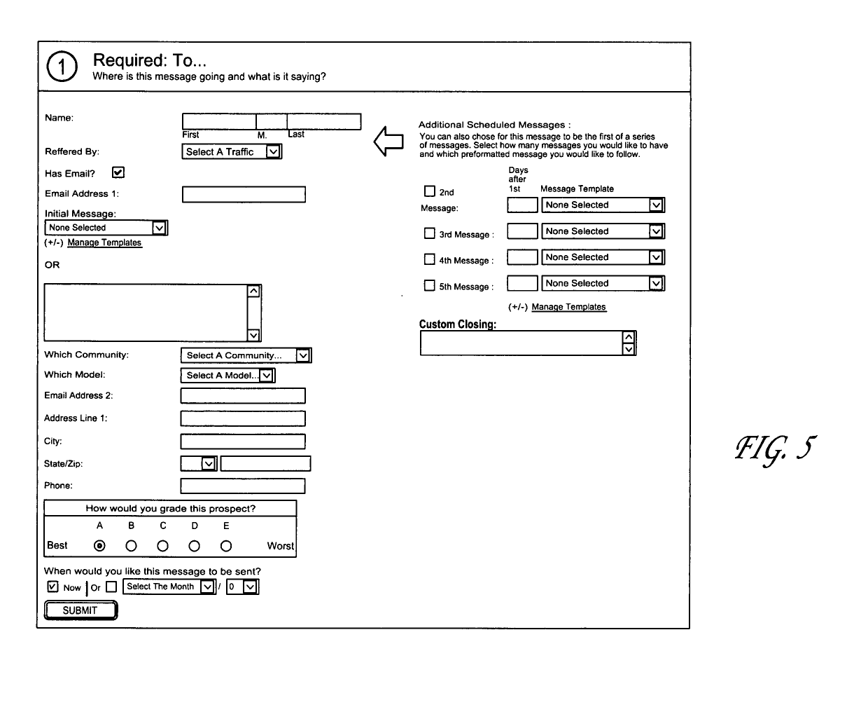

Once obtained and entered into SPCS 150, contact information is stored in prospect database 60. Contacts are preferably associated with individual salespersons although they may be grouped for various purposes such as community wide emails by, for example, a sales manager. New contact information may be input via, for example, the “Send an Email to a Prospect/Initial Prospect Entry” form illustrated in FIG. 5. As can be seen from this Figure, various required information is presented for input as is various optional information. In this example, the universe of information which may be specified includes name 510, email address 520, community name 530, and model of interest 540. A prospect grade may also be entered 550. This selection is made by the salesperson based upon the perceived level of interest by the potential customer. The salesperson may also include a personal note in box 560 to be included in a first email to the contact. In this way, the salesperson can personalize the email communication with each potential customer based upon, for example, noting something specific about the person or the initial meeting between the salesperson and potential customer. Alternatively, the salesperson may select a prewritten initial message via pull-down menu 570.

Using the selections through menus 580 the salesperson may specify the time and date at which the initial email should be sent. Further, assuming the salesperson has the required permissions, the salesperson may specify, through input area 590, the timing and content of future email communications to be sent to the particular potential customer. The number of days following the first email may be specified for each followup email as well as the particular content to be sent. Content may be individually customized assuming the required permissions or it may be based upon pre-specified templates in the system via the pull-down menus in input area 590.

Various optional information (not shown in the Figure) may also be provided via the input form of FIG. 5. For example, informal notes about the prospect may be associated with the particular prospect. Also, special features of interest to the prospect may be selected via checkboxes on the form. In addition, the salesperson may specify particular areas where the prospect requested additional information. All of these data fields can be used, as specified in more detail below, to customize mailings to the overall prospect base both in terms of content and targeted recipients.

Of course, other or additional information may form the groups of required and optional prospect information as desired by the particular salesperson, administrator or corporate level executive. As alluded to above, SPCS 150 is highly customizable so the various levels of decision makers can determine various operational characteristics of the system. The makeup of required and optional contact information is but one example of customizable operational characteristics made available by SPCS 150.

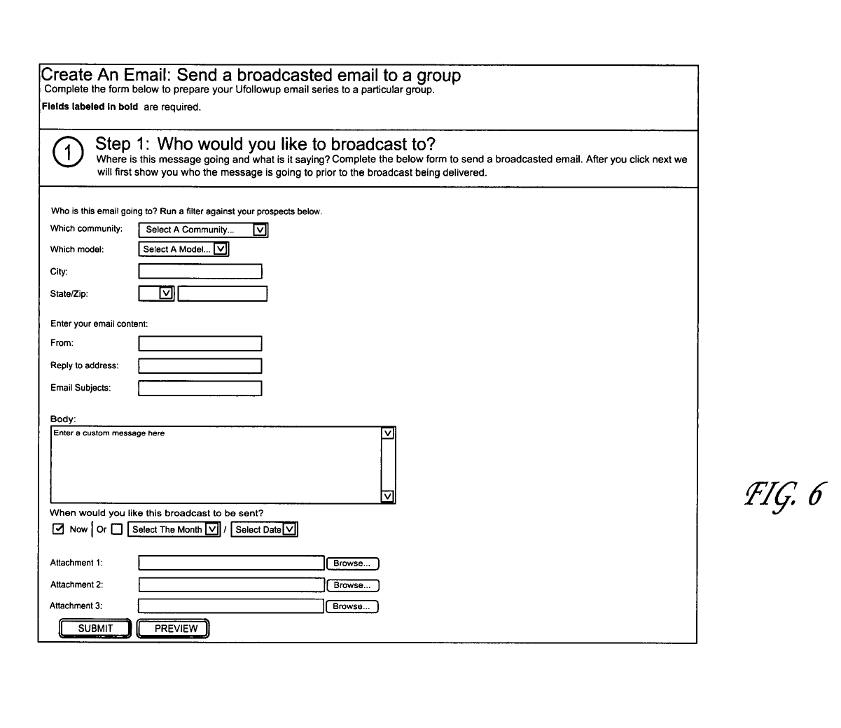

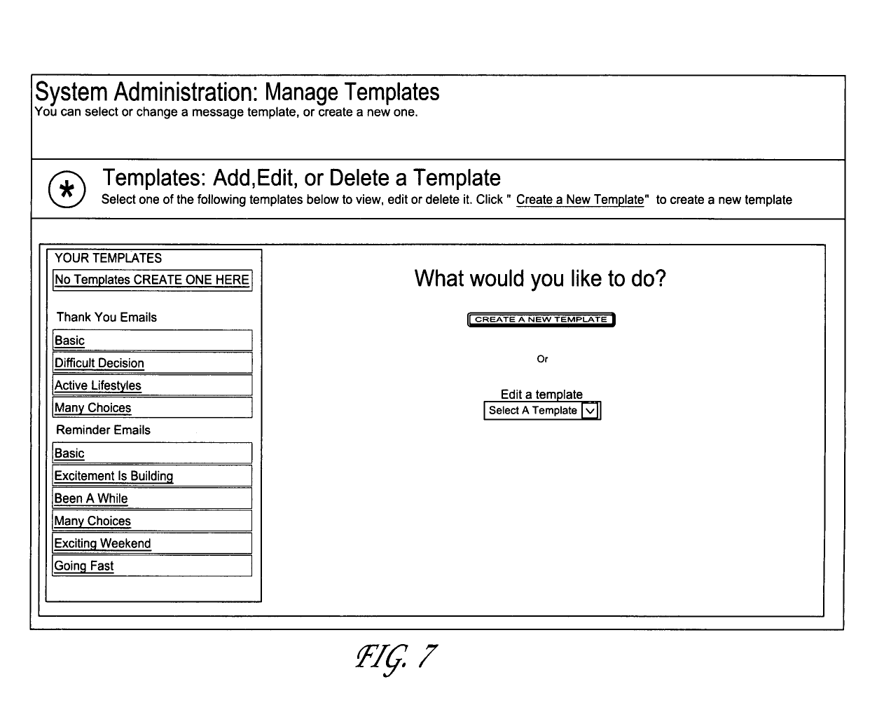

FIG. 6 is an illustrative form through which a salesperson or sales manager can send a broadcast email to a selected group of prospects. As can be seen from this form, a filter may be run against the overall database of prospects to select the targeted recipients for the particular mailing. In this context, SPCS 150 may be customized by a user with the appropriate level of permissioning to determine the available prospects to which a particular salesperson may mail to. In most cases, each salesperson will have the rights only to mail to prospects associated with that salesperson although other levels of access are also possible. For example, a salesperson may have the ability to mail to all prospects associated with a particular community, all prospects in the selling company's database, all company prospects with an interest level grade of “C” and below, all prospects associated with a particular grouping of salespeople or all prospects with initial data entry dates older than three months ago. Of course other controls and limitations are also possible and these options are limited only by the selection data available in the system databases.

Returning now to FIG. 6 and the process for sending a broadcast email, once the filter has been run, a list of prospects selected may be displayed for the salesperson further allowing the salesperson to add and delete selected recipients. Alternatively, SPCS may be customized to make the selection process and the selected recipients transparent to the users. The salesperson can provide specific content for the email message and select a date and time for the broadcast to occur. Additionally, the salesperson can select one or more attachments which may be included with the email message. Along these lines, the salesperson may browse among a group of available templates with or without predefined content. In other words, templates may be created to simply provide formatting for attachments and/or templates may provide predefinitions for both format and content.

In the example of FIG. 6, the broadcast email form allows a salesperson or sales manager to select email recipients based upon community of interest 610, model of interest 620, and/or city/state/zip of recipient 630 or any combination of these. Of course, other selection criteria are also possible. The salesperson or sales manager may also specify the from address, reply to address and subject for the broadcast email using input area 640. A specific message body may be entered in input box 650. Further, the salesperson or sales manager may specify immediate delivery or some later date/time for delivery via input area 660. One or more attachments stored either on the user's computer or in SPCS 150 itself may be selected for inclusion with the broadcast email via input areas 670. When the salesperson or sales manager has completed input, he or she may click on the submit button 680 to activate the broadcast email for immediate or delayed transmission.

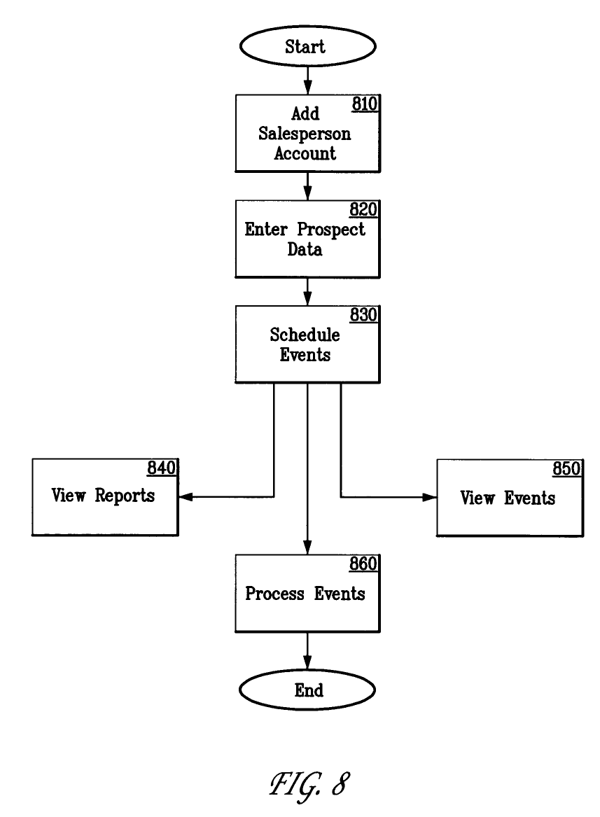

Although not generally a “user” function, FIG. 7 is an illustrative data entry form that permits creation, addition, modification and deletion of the templates just discussed. Typically, templates and their formats and content are controlled by a system administrator rather than a salesperson, although, again, SPCS 150 may be customized to permission in any way desired by the selling entity. As can be seen in FIG. 7, new templates may be created by selecting the new template function 710. Assuming proper permissions, templates may also be selected for editing via pull-down menu 720. Users may design their own templates by clicking on the “YOUR TEMPLATES” link In addition, templates may be grouped by purpose 740 as well as characteristics such as a thank you emails, purposed reminder email templates, a basic brochure attachment or a brochure attachment designed for transmission to prospect recipients designated as “active lifestyle” recipients. Other groupings and categorizations are possible and may be selected and operated according to the desires of the selling entity.

Further options and capabilities are available to users of SPCS 150 in connection with the broadcast of messages. For example, salespeople can create and modify a default schedule for sending communications to prospects. In connection with this feature, particular content and particular target recipient groups may also be specified. The scheduler can thus be set up by users to send messages to prospects on a particular schedule such as, for example, 3 days after initial visit, 10 days after visit, 15 days after visit etc. Any schedule of mailings may be selected by the system administrator, or by an individual user if they have been granted permission. In addition, specific templates including specific content and/or formatting may be selected to go with each of the mailings. In this way an automated campaign of follow-ups can be generated by users according to their preferences with no further action being required of them after initial set up. SPCS 150 may be configured to provide this scheduling control at the level of the salesperson, sales manager or administrator. Of course other permissioning schemes may also be used. In the case of, for example, control at the sales manager level, the sales manager may set the system to generate follow-up emails to all of the sales manager's salesperson's prospects on a schedule determined by the sales manager based upon days from initial visit of the prospect. Of course, scheduling of communications could also be based upon other events such as, for example, number of days prior to a sales event.

E. Reporting Functions

SPCS 150 of the present invention provides numerous reporting features and functions that allow salespersons and sales managers to track prospects and their responses as well as community sales figures and salesperson performance. The availability of these reports is in large part dependent on the type of data entered and the particular customization of the system.

Various possible reporting capabilities are now discussed. It will be obvious to one of skill in the art that these particular reports are merely exemplary and various other reports are possible limited only by the universe of data available in the system. One exemplary report allows salespersons and sales managers and other system users to obtain prospect grading reports. Assuming that, as discussed above, each prospect is assigned a grade indicative of level of interest or some other characteristic associated with the prospect, this report can be generated to provide grouped data. It is also preferable in the case of prospect grading for the salesperson to periodically adjust the grade (or other associated characteristic value) based upon prospect behavior over time. Given that, SPCS 150 can generate reports providing an overview of level of interest (or other characteristic) associated with a particular community, particular salesperson, particular timeframe or overall for example, with respect to a whole selling company. Other data filters are also possible. This report, as well as other reports discussed herein or otherwise, are preferably downloadable in various formats including in spreadsheet format.

Another report that may be generated is a follow-up phone call status report. This report may be associated with a particular salesperson and permits the salesperson to see, at a glance, all follow-up activities which should be accomplished by the salesperson. This report may be filtered by time period (i.e. when the activity is due to be completed), by community, by prospect grouping, etc. Thus, for example, a salesperson could easily call up all activities due with respect to his or her prospects for a certain day including, for example, phone calls to be made, personalized emails to be drafted and sent, or responses to other requests made by prospects.

Yet another exemplary class of reports allow system users to view various data concerning emails that have been sent. These reports may have associated permissions such that only certain users may have access to them. For example, SPCS 150 may be configured so that only a sales manager can have overall access to all of the salesperson's sent email reports. These reports may include reports that detail emails sent out over a specific period such as, for example, a specific day. The report may summarize the number of emails to be sent on a particular day as well as the number of phone calls to be made on that same day (see above report). Tabular data may also be presented showing the detailed information such as the particular recipients, their community of interest, their interest grade and the date of their first initial visit. Searching capability may also be provided to access various data within the reports.

Click through reporting may also be provided to system users. In these reports, summaries and detailed information may be provided with respect to individual prospects and prospect groupings regarding which prospects opened which emails and when as well as email “bounceback” information. Data regarding website visits may also be collected and presented as is known in the art. Additionally, bounced messages and associated email addresses and transmission data as well as summary reports summarizing the same may be provided.

Another class of reports allows sales managers to track salesperson performance. Both summary charts and drill-down information may be provided. For example, data by community or by time period may be presented. By way of example, these reports may show the number of prospects associated with each salesperson, the number of emails sent by each salesperson, the number of phone calls made by each salesperson and the dollar volume of sales and number of transactions achieved by each salesperson or by selected groupings of salespersons.

### EXAMPLE

In order to provide additional explanation regarding the operation of SPCS 150, the following discussion of practical application is provided in connection with FIG. 8. This discussion assumes application in connection with use by a fictitious homebuilding company called ABC Homes. It is further assumed that ABC Homes employs a salesperson named John Rogers and that John Rogers has home purchasing prospects Joe Homebuyer and Jane Smith.

According to this example, ABC Homes may appoint an administrator with broad privileges in terms of data access and modification as well as account setup. First, the administrator adds a salesman account for John Rogers 810. The account may contain personal and contact information for John Rogers all well as business information including his phone number and other information. Once John is set up with an account in the system, he (or his assistant) may enter prospect information as it becomes available 820. So, for example, if Joe Homebuyer comes into the sales trailer one day, John may ask Joe some questions to allow him to populate the prospect record for Joe. Alternatively, John may ask Joe to fill out a form requesting the information. By way of example, John may enter, via a web based interface input form, Joe Homebuyer's name, his email address and the community and model of interest to Joe. Additionally, John may assign a “grade” to Joe based upon John's assessment of Joe's level of interest in buying a home in the specified community. At the time of data entry, John may also type in a personal note that would be included in the first contact email to be sent to Joe. Various additional data concerning Joe may also be entered such as what special features are of interest to Joe and what type of additional information was requested by Joe. For purposes of this example, assume that Joe has an interest in the financing options special feature and that he has requested more information about golf courses in the area. All of this data is entered and upon clicking of the submit button, a data record is created for Joe as a prospect within the system.

John may also enter additional prospect records as prospects come available. For example, he may meet Jane Smith at a homebuying fair, ask her to fill out a datacard and he may later enter prospect information provided by Jane as well as a prospect grade assigned by John. For purposes of this example, assume that Jane is interested in the supermarkets special feature and has requested additional information concerning the availability of swimming pools. John enters all of this information, presses the submit button and a prospect record is created for Jane.

Now that John has prospects entered into the system, he may now set up an email communications schedule using the scheduling feature of the present invention 830. In this regard, he may, for example, set up scheduling so that an introductory email goes out to all prospects (thus including both Jane and Joe) five days after the initial contact between John and the prospect. At the time of data entry, John can enter the date of the initial contact. Perhaps emails with different content go out at later dates such as 15, 30 and 45 days after the initial meeting. All of this can be setup ahead of time by John and modified as necessary depending upon how the sales cycle proceeds with the particular prospects and based upon external events.

As an example of the latter, assume that the city announces a new golf course to be developed adjacent to the community of interest to Joe. John may create a specific mailing to only prospects that have included a “request for more information” pertaining to golf courses. Based upon this example, the mailing would go to Joe but not to Jane because of indicated interests. Further, the mailing may include specific content regarding the new golf course development. As another example, prospects may be keyed by whether they are interested in single family homes or townhomes. In this case, when a new community with either or both is added to the system or when it is otherwise desired to contact buyers with specific model interests, the selected prospects may be contacted based on this and/or other criteria.

As discussed above, the follow up aspects of the present invention are also available to John. So, for example, John could log on in the morning and readily determine the scheduled emails set to be transmitted for the day 850. The same report may also indicate to John calls that he should make to prospects based upon emails that he has previously sent out or other external events giving rise to action items on the part of John. Various other reports are also available to John and to his sales manager as described in detail above 840. As discussed above, SPCS 150 will automatically initiate events such as broadcast emails based upon the default criteria or some override specified by a user 860.

It will be readily understood that the example provided above is anything but limiting and that various other applications, data and reporting capabilities can be provided by the system of the present invention while remaining within the scope and spirit of the invention. For example, the invention may have application in connection with sales of new homes, sales of resale homes, sales of cars, the renting of properties by rental agents and sales of other vehicles including boats. An additional application includes use by mortgage brokers in connection with prospect management as well as communication during the loan underwriting process. Yet another exemplary application involves use in connection with media sales and college student recruiting including the recruiting of college athletes. As will be readily understood, the above applications are merely exemplary and the communication system and methodologies taught herein have practically unlimited application in any case where one entity is seeking to communicate with multiple target recipients during some form of ongoing process requiring communication or making communication desirable.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

1. A communications processing system for automating communication between a sender and one or more recipients comprising:
(a) at least one sender terminal for receiving and displaying information;
(b) at least one recipient terminal for receiving and displaying information;
(c) a communications network through which said at least one sender terminal may communicate with at least one recipient terminal; and
(d) a communications scheduling engine, said communications scheduling engine automatically generating communications between said sender and said recipient on a sender specified schedule;
(e) wherein said communications scheduling engine is configurable to selectively permit or deny the generation of communications by said sender to at least one of said one or more recipients.

2. The communications processing system of claim 1 wherein said selective permission or denial of communications to said at least one of said one or more recipients is determined by the relationship between said at least one recipient and said sender.

3. The communications processing system of claim 1 wherein said communications network is the internet.

4. The communications processing system of claim 1 wherein said communications network is a private network.

5. The communications processing system of claim 1 wherein said communications generated by said communications scheduling engine are electronic mails.

6. The communications processing system of claim 5 wherein said communications generated by said communications scheduling engine further comprise at least one attachment.

7. The communications processing system of claim 6 wherein said at least one attachment is based upon a template stored within said communications processing system.

8. The communications processing system of claim 5 wherein a plurality of communications are generated by said communications scheduling engine and said communications are transmitted by said communications scheduling engine on a scheduled basis dependent upon the number of days elapsed from a particular event.

9. The communications processing system of claim 1 wherein at least one of the characteristics of a user interface located on said seller terminal is determined by the identity of the seller.

10. A sales prospect management system for maintaining interaction between a seller and at least one prospect, said sales prospect management system comprising:
a seller subsystem, said seller subsystem further comprising at least one communications terminal for interacting with at least one database;
a communications network through which said seller subsystem communicates with said at least one prospect;
wherein said seller subsystem issues commands causing the generation of electronic mail including data from said at least one database and wherein said electronic mail is transmitted to said at least one prospect on a schedule specified through said seller subsystem.

11. The sales prospect management system of claim 10 wherein said at least one database comprises a content database containing data describing homes for sale.

12. The sales prospect management system of claim 11 wherein said content database further contains images of said homes for sale.

13. The sales prospect management system of claim 10 wherein said at least one database comprises a template database containing templates which control the format of said electronic mail.

14. The sales prospect management system of claim 10 wherein a specific subset of said at least one prospect is selected to receive said electronic mail based upon criteria associated with each of said at least one prospects.

15. A method for managing a sales process so as to provide periodic communication between a seller and a plurality of prospects, said method comprising the steps of:
(a) providing content associated with at least one offering;
(b) providing a list of said plurality of prospects, said list including an email address associated with each of said prospects;
(c) providing a schedule specifying the timing of emails to be transmitted in connection with said at least one offering; and
(d) transmitting said emails containing said content to one or more of said prospects according to said schedule and according to a selection criteria applied to determine the prospects to receive said emails.

16. The method of claim 15 wherein said schedule calls for a plurality of email transmissions each based upon a specific elapsed time since an initial event.

17. The method of claim 15 wherein said content is formatted in said emails according to at least one stored template.
